(19) United States
(12) Patent Application Publication
(10) Pub. No.: US 2011/0224945 A1
(43) Pub. Date: Sep. 15, 2011

(54) METHOD OF PERFORMING ETCH PROXIMITY CORRECTION, METHOD OF FORMING PHOTOMASK LAYOUT USING THE METHOD, COMPUTER-READABLE RECORDING MEDIUM STORING PROGRAMMED INSTRUCTIONS FOR EXECUTING THE METHOD, AND MASK IMAGING SYSTEM

(75) Inventors: Seong-bo Shim, Suwon-si (KR); Sang-wook Kim, Yongin-si (KR); Chun-suk Suh, Yongin-si (KR); Seong-woon Choi, Suwon-si (KR); Sung-woo Lee, Suwon-si (KR)

(73) Assignee: SAMSUNG ELECTRONICS CO., LTD., Gyeonggi-do (KR)

(21) Appl. No.: 13/042,760

(22) Filed: Mar. 8, 2011

(30) Foreign Application Priority Data
Mar. 11, 2010 (KR) 10-2010-0021837

(51) Int. Cl. G06F 19/00

(52) U.S. Cl. 702/150

(57) ABSTRACT

A method of performing etch proximity correction, taking into account an orientation-dependent component, includes providing a layout, selecting a target point on an edge of the layout, defining a proximity range from the target point, defining a probability function including a distance-dependent component, an orientation-dependent component, or both a distance-dependent component and an orientation-dependent component with respect to the proximity range, and calculating a surface integral of the probability function over the proximity range.

### CROSS-REFERENCE TO RELATED APPLICATIONS

This application claims the benefit of Korean Patent Application No. 10-2010-0021837, filed on Mar. 11, 2010, in the Korean Intellectual Property Office, the entire contents of which are incorporated herein by reference.

### BACKGROUND

The inventive concept relates to a method of performing an etch proximity correction, and more particularly, to a method of performing etch proximity correction by taking account of an orientation-dependent component; a method of creating a photomask layout using the method; a computer-readable recording medium storing programmed instructions for executing the method; and a mask imaging system.

The scaling down of integrated circuits has been accelerated due to the development of photolithography technology. Therefore, the size of a pattern transferred onto a wafer is smaller than a wavelength of an exposure beam. As a result, optical proximity correction (OPC) for compensating for light diffraction and interference phenomena has been recognized as an important process for fine and reliable micro-patterning. OPC is a photolithography enhancement technique commonly used to compensate for image errors due to diffraction or process effects. The need for OPC is seen mainly in the making of semiconductor devices and is due to the limitations of light to maintain the edge placement integrity of the original design, after processing, into the etched image on the silicon wafer. These projected images appear with irregularities such as line widths that are narrower or wider than designed. Other distortions such as rounded corners are driven by the resolution of the optical imaging tool and are harder to compensate for. Such distortions, if not corrected for, may significantly alter the electrical properties of what is being fabricated. The objective is to reproduce, as well as possible, the original layout drawn by the designer in the silicon wafer.

In the OPC process, there is an increasing demand for etch proximity correction for minimizing an etch effect due to proximate micro-patterns.

### SUMMARY

According to an aspect of the inventive concept, there is provided a method of performing etch proximity correction. The method includes providing a layout, selecting a target point on an edge of the layout, defining a proximity range from the target point, defining a probability function including a distance-dependent component, an orientation-dependent component, or both a distance-dependent component and an orientation-dependent component with respect to the proximity range, and calculating a surface integral of the probability function over the proximity range.

In some embodiments of the inventive concept, the orientation-dependent component may change depending on an azimuth from a reference line passing through the target point. The reference line may extend perpendicular to the edge. The orientation-dependent component may be symmetric with respect to the reference line. The orientation-dependent component may decrease as the azimuth increases. The orientation-dependent component may be proportional to a cosine value of the azimuth. The orientation-dependent component may further include an elliptic ratio. The orientation-dependent component may be proportional to cos(Er×θ), in which Er represents the elliptic ratio and B represents the azimuth. The orientation-dependent component may include a Gaussian function of the azimuth having a relationship expressed as

$$G ( θ ) = a {e}^{- {( \frac{θ}{b} )}^{2}} ,$$

where θ represents the azimuth, a and b represent constants, and G(θ) represents the Gaussian function.

The orientation-dependent component may include a Gaussian function of the azimuth having a relationship expressed as

$$G ( θ ) = a {e}^{- {( \frac{Er θ}{b} )}^{2}} ,$$

where Er represents the elliptic ratio, θ represents the azimuth, a and b represent constants, and G(θ) represents the Gaussian function.

In some embodiments of the inventive concept, the distance-dependent component may change depending on a distance from the target point. The distance-dependent component may decrease as the distance increases. The distance-dependent component may be proportional to a reciprocal of the distance. The distance-dependent component may include a Gaussian function of the distance having a relationship expressed as

$$G ( r ) = a {e}^{- {( \frac{r}{b} )}^{2}}$$

where r represents the distance, a and b represent constants, and G(r) represents the Gaussian function.

In some embodiments of the inventive concept, the proximity range may be dependent upon the orientation-dependent component. The proximity range may change with an elliptic ratio.

In some embodiments of the inventive concept, the selecting of the target point may include selecting a middle point of the edge as the target point.

According to another aspect of the inventive concept, there is provided a method of forming a photomask layout. The method includes designing a layout, performing etch proximity correction with respect to the layout, and correcting the layout by using the etch proximity correction. The performing of the etch proximity correction includes providing a layout, selecting a target point on an edge of the layout, defining a proximity range from the target point, defining a probability function including a distance-dependent component, an orientation-dependent component, or both a distance-dependent component and an orientation-dependent component with respect to the proximity range, and calculating a surface integral of the probability function over the proximity range.

According to another aspect of the inventive concept, there is provided a computer-readable recording medium storing programmed instructions for executing a method of performing etch proximity correction on a computer. The method includes providing a layout, selecting a target point on an edge of the layout, defining a proximity range from the target point, defining a probability function including a distance-dependent component, an orientation-dependent component, or both a distance-dependent component and an orientation-dependent component with respect to the proximity range, and calculating a surface integral of the probability function over the proximity range.

According to another aspect of the inventive concept, there is provided a system for performing etch proximity correction. The system includes a providing mechanism configured to provide a layout, a selecting mechanism configured to select a target point on an edge of the layout, a defining mechanism configured to define a proximity range from the target point, a defining mechanism configured to define a probability function including a distance-dependent component, an orientation-dependent component, or both a distance-dependent component and an orientation-dependent component with respect to the proximity range, and a calculating mechanism configured to calculate a surface integral of the probability function over the proximity range.

According to another aspect of the inventive concept, there is provided a system for performing etch proximity correction, the system including a storage apparatus for storing a layout and a processing apparatus for receiving the layout from the storage apparatus. The processing apparatus selects a target point on an edge of the layout, defines a proximity range from the target point, defines a probability function including at least one of a distance-dependent component and an orientation-dependent component with respect to the proximity range, and calculates a surface integral of the probability function over the proximity range.

In some embodiments, the orientation-dependent component changes depending on an azimuth from a reference line passing through the target point. The orientation-dependent component may decrease as the azimuth increases. The orientation-dependent component may further comprise an elliptic ratio. The distance-dependent component may change depending on a distance from the target point. The distance-dependent component ma decrease as the distance increases. The distance-dependent component may be proportional to a reciprocal of the distance. The proximity range may be dependent upon the orientation-dependent component. The proximity range may change with an elliptic ratio.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The foregoing and other features and advantages of the inventive concept will be apparent from the more particular description of preferred embodiments of the inventive concept, as illustrated in the accompanying drawings in which like reference characters refer to the same parts throughout the different views. The drawings are not necessarily to scale, emphasis instead being placed upon illustrating the principles of the inventive concept.

FIG. 1 contains a schematic diagram illustrating a method of performing etch proximity correction, according to embodiments of the inventive concept.

FIG. 2 contains a flowchart of a method of forming a photomask layout, according to embodiments of the inventive concept.

FIG. 3 contains a flowchart of a method of performing etch proximity correction in the forming method shown in FIG. 1, according to embodiments of the inventive concept.

FIGS. 4 through 7 contain graphs of a distribution of a probability function according to embodiments of the inventive concept.

FIGS. 8 and 9 illustrate graphs showing a proximity range changing with an elliptic ratio according to embodiments of the inventive concept.

FIG. 10 contains a schematic block diagram of a system for executing a method of forming a photomask layout, according to embodiments of the inventive concept.

### DETAILED DESCRIPTION OF THE EMBODIMENTS

Reference will now be made in detail to exemplary embodiments, which are illustrated in the accompanying drawings. However, embodiments of the inventive concept are not limited to the exemplary embodiments described and illustrated hereinafter, and the embodiments described and illustrated herein provide complete understanding of the inventive concept.

It will be understood that when an element, such as a layer, a region, or a substrate, is referred to as being “on,” “connected to” or “coupled to” another element, it may be directly on, connected or coupled to the other element, or intervening elements may be present. In contrast, when an element is referred to as being “directly on,” “directly connected to” or “directly coupled to” another element or layer, there are no intervening elements or layers present. Like reference numerals refer to like elements throughout. As used herein, the term “and/or” includes any and all combinations of one or more of the associated listed items.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of exemplary embodiments.

Spatially relative terms, such as “above,” “upper,” “beneath,” “below,” “lower,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “above” may encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the inventive concept. As used herein, the singular forms “a,” “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof.

Exemplary embodiments may be described herein with reference to cross-sectional illustrations that are schematic illustrations of exemplary embodiments (and intermediate structures). As such, variations from the shapes of the illustrations as a result, for example, of manufacturing techniques and/or tolerances, are to be expected. Thus, exemplary embodiments should not be construed as limited to the particular shapes of regions illustrated herein but may include deviations in shapes that result, for example, from manufacturing. For example, an implanted region illustrated as a rectangle may, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes may not be intended to illustrate the actual shape of a region of a device and are not intended to limit the scope of the inventive concept.

Unless otherwise defined, all teems (including technical and scientific tennis) used herein have the same meaning as commonly understood by one of ordinary skill in the art to which the exemplary embodiments pertain. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A process of forming a wafer pattern with a designed layout includes selectively exposing a photoresist layer, developing an exposed portion of the photoresist layer to form a photoresist pattern, and selectively etching an etch target layer using the photoresist pattern as an etch mask. Factors to be considered in an optical proximity correction (OPC) process are associated with pattern transferring stages. The related optical proximity effect may be considered to be a substantial pure optical proximity effect and a non-optical proximity effect. The pure optical proximity effect may be relatively accurately modeled when an illumination condition and a wavelength of an exposure light source are determined. Among factors of the non-optical proximity effect, a photoresist-related factor may be relatively predictably modeled with many experiments and the development of a modeling method. In contrast, an etch process, which is another factor of the non-optical proximity effect, uses plasma and is affected by various parameters, and, therefore, can be difficult to model. Moreover, accurate prediction of a cross section of a three-dimensional (3D) portion of a pattern, is very difficult to achieve, and a portion related to a critical dimension (CD) of a two-dimensional (2D) pattern is also difficult to predict accurately. In particular, as the size to be realized in a semiconductor device decreases to a micro size, the ability to form an accurate pattern using only the pure optical proximity correction because it does not take account of an etch effect.

The etch proximity effect is associated with a physical interaction, a chemical interaction, and substance transfer in an etch chamber. The etch proximity effect is also considerably affected by the actual layout of the integrated circuit to be formed on a wafer. For example, a significant cause of the etch proximity effect is deposition of passivant molecules from a gas state during an etch process. Such passivant molecules linearly move along with gas and are deposited onto sidewalls of features of the integrated circuit. Thus, the geometry of a layout may be an important factor in deposition of passivant molecules. Therefore, it is necessary to consider the orientation and relative arrangement of features included in the layout.

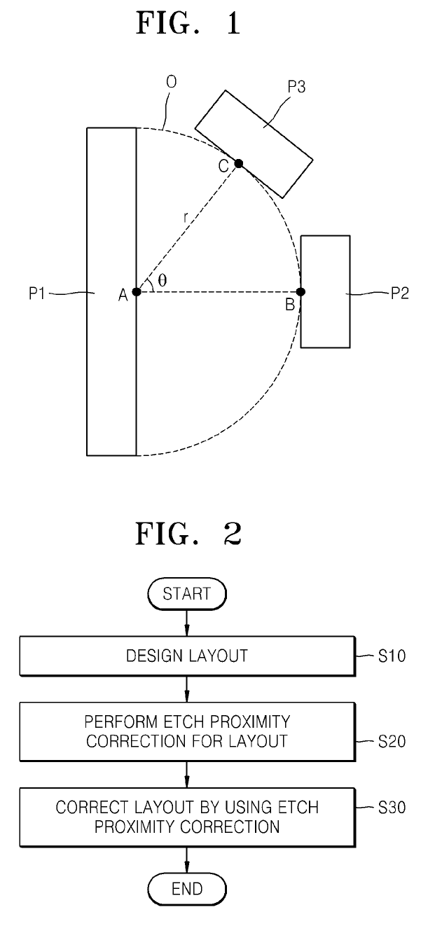

FIG. 1 contains a schematic diagram illustrating a method of performing etch proximity correction, according to some embodiments of the inventive concept.

Referring to FIG. 1, three features, namely, first to third features P1, P2, and P3, are shown. The first feature P1 is a reference feature, and the second feature P2 and the third feature P3 are spaced apart from the first feature P1 by the same distance r. That is, the length of a segment “AC” and the length of a segment “AB” are equal to each other. Thus, when an interaction between features exists only based on the distance, an influence of the second feature P2 and an influence of the third feature P3 upon a point “A” on the first feature P1 may be the same. However, when the interaction also depends on a relative orientation of features, the influence of the second feature P2 and the influence of the third feature P3 may be different. For example, the influence of the second feature P2 positioned perpendicular to the point “A” (that is, positioned on the segment “AB” perpendicular to an edge including the point “A”) may be larger than the influence of the third feature P3 positioned inclined with respect to the point “A”. In the following description, the point “A” will be referred to as a target point, the segment “AB” as a reference line, a semicircular region “O” as a proximity range, and an angle CAB, that is, θ as an azimuth. The first feature P1, the second feature P2, and the third feature P3 will be referred to as a layout.

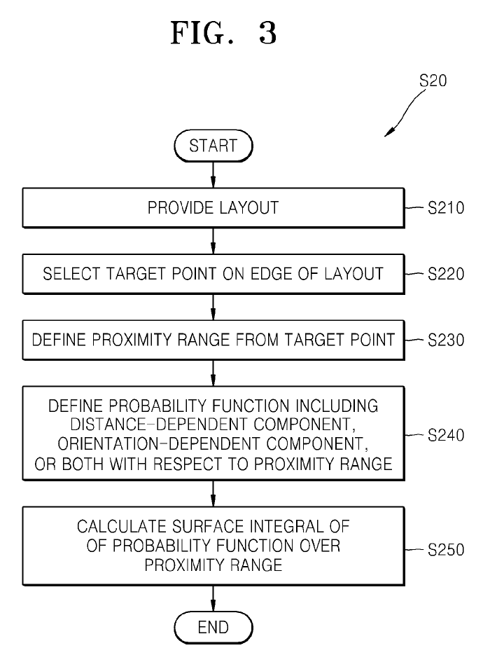

FIG. 2 contains a flowchart of a method of forming a photomask layout, according to some embodiments of the inventive concept. FIG. 3 illustrates a flowchart of a method of performing etch proximity correction in the forming method shown in FIG. 1, according to an embodiment of the inventive concept.

Referring to FIG. 2, the method of forming a photomask layout includes operation S10 of designing a layout, operation S20 of performing etch proximity correction on the layout, and operation S30 of correcting the layout using the etch proximity correction.

Referring to FIG. 3, operation S20 of performing etch proximity correction includes operation S210 of providing the layout, operation S220 of selecting a target point on an edge of the layout, operation S230 of defining a proximity range from the target point, operation S240 of defining a probability function including a distance-dependent component, an orientation-dependent component, or both a distance-dependent component and an orientation-dependent component with respect to the proximity range, and operation S250 of calculating a surface integral of the probability function over the proximity range.

The etch proximity correction operation S20 of FIGS. 2 and 3 will be described with reference to FIG. 1. The first feature P1 is provided as the layout in operation S210. Next, the point “A” is selected as the target point on the edge of the first feature P1, in operation S220. The middle point of the edge may be selected as the target point, but this is only illustrative, and the inventive concept is not limited to this example. The semicircular region “O” from the target point “A” is defined as the proximity range, in operation 5230. Next, a probability function including a distance-dependent component, an orientation-dependent component, or both a distance-dependent component and an orientation-dependent component with respect to the semicircular region “O” defined as the proximity range is defined in operation S240. The surface integral of the probability function is calculated over the semicircular region “O” defined as the proximity range, in operation S250. The calculated surface integral of the probability function may model etch proximity effects related to positions of visible features from the target point.

In the following description, the probability function will be described in detail below. As described above, the probability function may include a distance-dependent component, an orientation-dependent component, or both a distance-dependent component and an orientation-dependent component.

The orientation-dependent component may change depending on an azimuth from a reference line passing through the target point. The reference line may extend perpendicular to the edge. Since the azimuth may be located at both sides with respect to the reference line, the orientation-dependent component may be symmetric with respect to the reference line. For example, the orientation-dependent component may decrease as the azimuth increases. The orientation-dependent component may be proportional to a cosine value of the azimuth, as given below.

f₁=a cos θ (1)

In Equation (1), f₁ represents the orientation-dependent component, θ represents the azimuth, and a represents a constant.

The orientation-dependent component may further include an elliptic ratio. The elliptic ratio is defined as the ratio of the length of the major axis to the length of the minor axis of an ellipse defined in the proximity range. For example, the orientation-dependent component may be proportional to cos(Er×θ), as given below.

f¹=a cos(Er×θ) (2)

In Equation (2), f represents the orientation-dependent component, Er represents the elliptic ratio, θ represents the azimuth, and a represents a constant.

The orientation-dependent component may include a Gaussian function with respect to the azimuth. For example, the orientation-dependent component having a relationship expressed below may include a Gaussian function with respect to the azimuth.

$${f}_{1} = G ( θ ) = a {e}^{- {( \frac{θ}{b} )}^{2}} \qquad ( 3 )$$

In Equation (3), f₁ represents the orientation-dependent component, θ represents the azimuth, a and b represent constants, and G(θ) represents the Gaussian function.

The orientation-dependent component having a relationship expressed below may include an elliptic ratio and for example, may include a Gaussian function with respect to the azimuth.

$${f}_{1} = G ( θ ) = a {e}^{- {( \frac{Er θ}{b} )}^{2}} \qquad ( 4 )$$

In Equation (4), f₁ represents the orientation-dependent component, Er represents the elliptic ratio, B represents the azimuth, a and b represent constants, and G(θ) represents the Gaussian function.

The distance-dependent component may change depending on a distance from the target point. For example, the distance-dependent component may decrease as the distance increases. The distance-dependent component having a relationship expressed below may be proportional to a reciprocal of the distance.

$${f}_{2} = \frac{a}{r} \qquad ( 5 )$$

In Equation (5), f₂ represents the distance-dependent component, r represents the distance, and a represents a constant.

The distance-dependent component may include a Gaussian function with respect to a distance. For example, the distance-dependent component having a relationship expressed below may include a Gaussian function with respect to a distance.

$${f}_{2} = G ( r ) = a {e}^{- {( \frac{r}{b} )}^{2}} \qquad ( 6 )$$

In Equation (6), f₂ represents the distance-dependent component, r represents the distance, a and b represent constants, and G(r) represents the Gaussian function.

As stated previously, the probability function may include a distance-dependent component, an orientation-dependent component, or both a distance-dependent component and an orientation-dependent component. If the probability function includes only the orientation-dependent component, the probability function may be expressed as one of Equations (1) through (4) or a combination thereof. On the other hand, if the probability function includes only the distance-dependent component, the probability function may be expressed as Equation (5), Equation (6), or a combination thereof. If the probability function includes both of the orientation-dependent component and the distance-dependent component, the probability function may be expressed as a product of the orientation-dependent component and the distance-dependent component and may have a relationship as expressed below.

F(r,θ)=f₁×f₂ (7)

In Equation (7), F represents the probability function, f₁ represents the orientation-dependent component, f₂ represents the distance-dependent component, r represents the distance, and θ represents the azimuth.

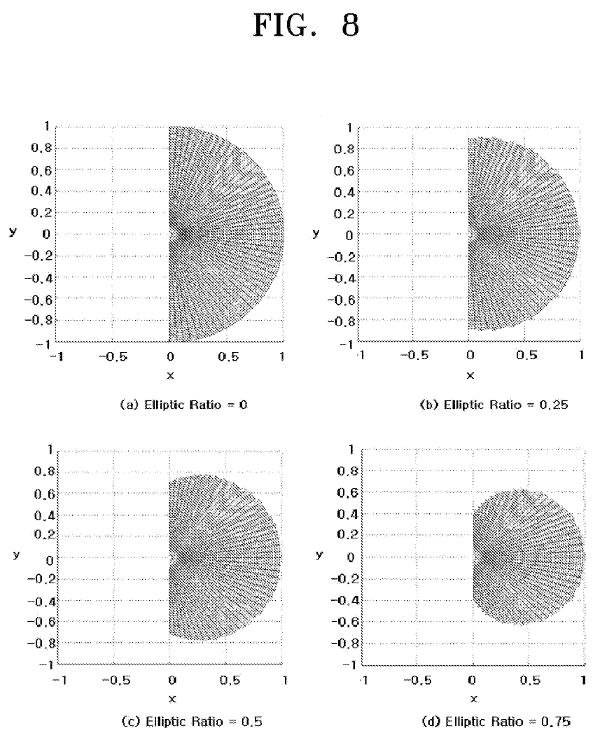

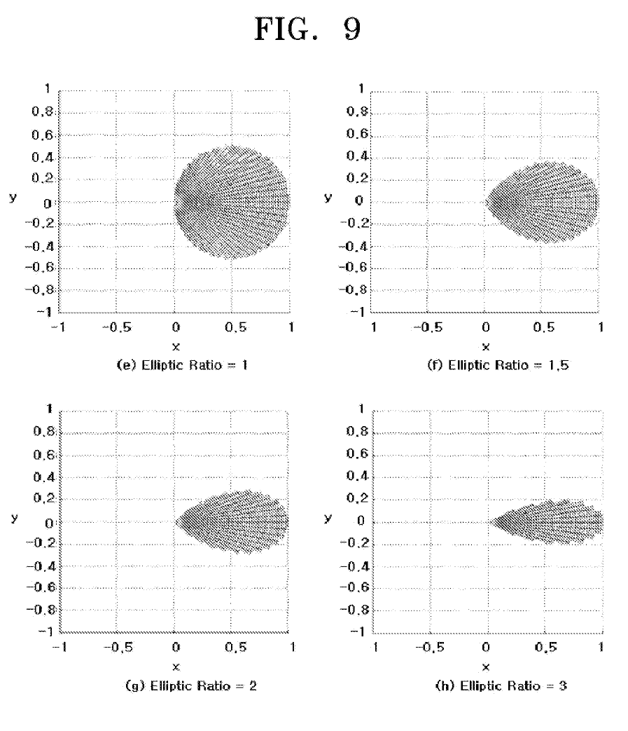

In some embodiments of the inventive concept, the proximity range may include the orientation-dependent component. The proximity range may change with an elliptic ratio as will be described in detail below with reference to FIG. 8.

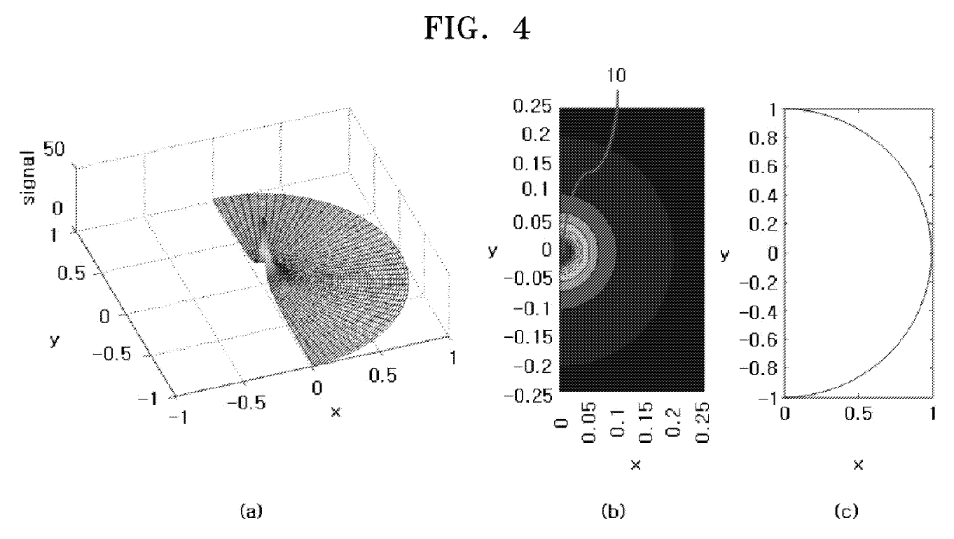

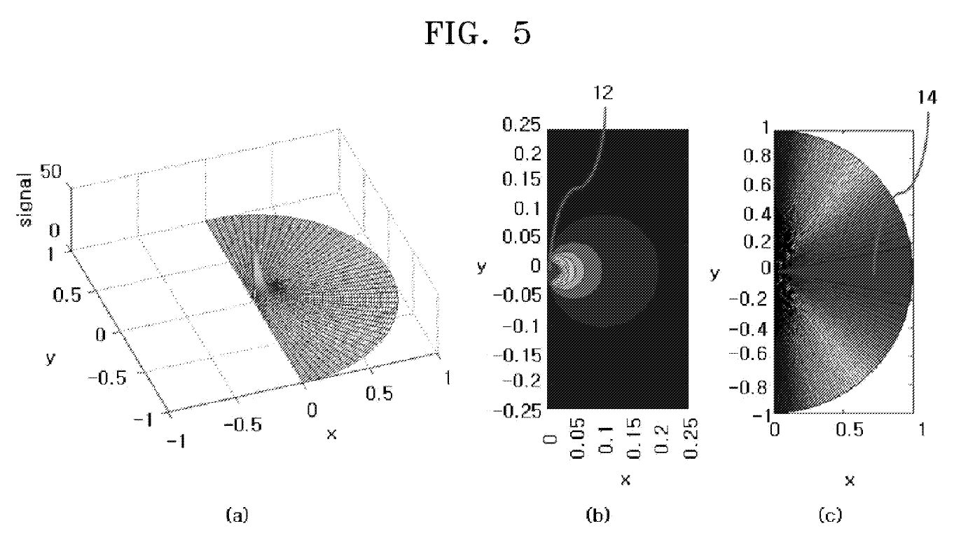

FIGS. 4 through 7 illustrate graphs of a distribution of a probability function according to embodiments of the inventive concept. In each of FIGS. 4 through 7, (a) shows a probability function illustrated three-dimensionally, (b) shows a probability function of a portion of (a) two-dimensionally, and (c) shows an orientation-dependent weight.

Referring to FIG. 4, the probability function uses Equation (5). That is, the probability is proportional to a reciprocal of a distance, irrelevant to the azimuth. Thus, the probability function produces a high value near the target point indicated in FIG. 4 (b) by reference numeral 10 (the color changes from blue to red as the value increases). On the other hand, as shown in (c), the orientation-dependent weight is uniform over all orientations.

Referring to FIG. 5, the probability function uses a combination of Equation (1) and Equation (5). That is, the probability function is associated with a distance and the azimuth and has a relationship expressed below.

$$F ( r , θ ) = \frac{a}{r} cos θ \qquad ( 8 )$$

In Equation (8), F represents the probability function, θ represents the azimuth, r represents the distance, and a represents a constant.

The probability function produces a high value near the target point, that is, as the distance r decreases, indicated in FIG. 5 (b) by reference numeral 12. The probability function also produces a high value as the azimuth approaches 0, that is, a reference line. As shown in (c), the orientation-dependent weight may increase as the azimuth approaches 0. In (c), the red region labeled 14 indicates the highest value of the probability function.

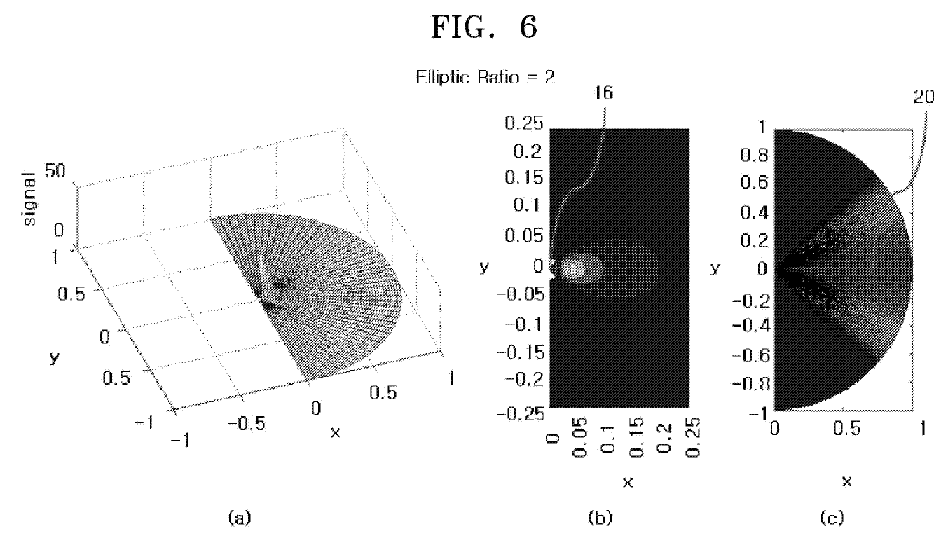

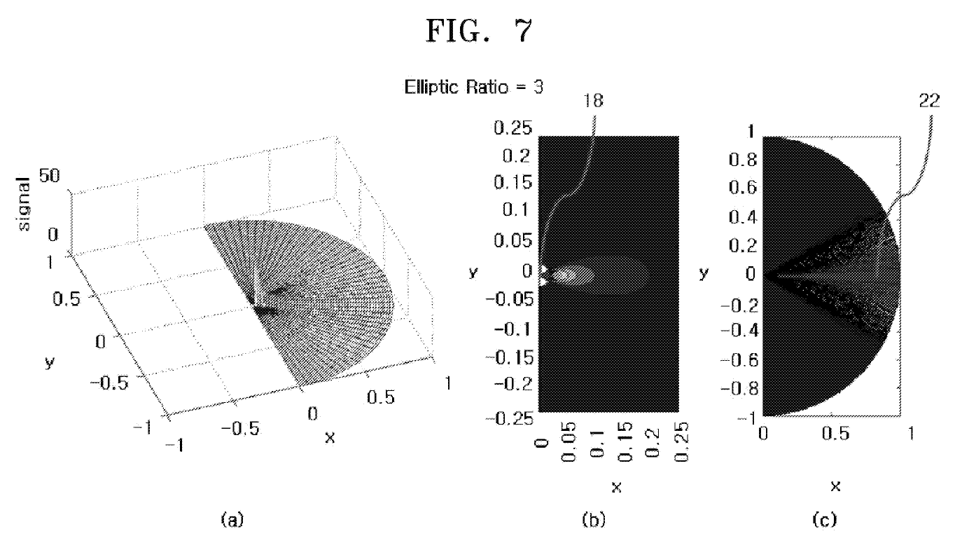

Referring to FIGS. 6 and 7, the probability uses a combination of Equation (2) and Equation (5). That is, the probability function having a relationship expressed below is associated with the distance and the azimuth and also with the elliptic ratio. The elliptic ratio is 2 in FIG. 6, and the elliptic ratio is 3 in FIG. 7.

$$F ( r , θ ) = \frac{a}{r} cos ( Er \times θ ) \qquad ( 9 )$$

In Equation (9), F represents the probability function, Er represents the elliptic ratio, θ represents the azimuth, r represents the distance, and a represents a constant.

The probability function produces a high value near the target point, that is, as the distance r decreases, indicated in FIG. 6 (b) by reference numeral 16 and in FIG. 7 (b) by reference numeral 18. The probability function also produces a high value as the azimuth approaches 0, that is, near the reference line. As the elliptic ratio increases, the value of the probability function increases in a region near the reference line. As shown in (c) of FIGS. 6 and 7, the orientation-dependent weight increases as the azimuth approaches 0 and as the elliptic ratio increases. In (c) of FIGS. 6 and 7, the red regions indicated by reference numeral 20 in FIG. 6 (c) and by reference numeral 22 in FIG. 7 (c) indicate the highest value of the probability function.

As described above, by defining the probability function to have the orientation-dependent component, the influences of features which are positioned with the same distance, but have different orientations in a particular layout may be analyzed precisely. In particular, the influences of a feature positioned upwardly perpendicular to the target point and a feature positioned inclined with respect to the target point upon the layout may be analyzed more closely to actual feature influences. Therefore, the layout can be more accurately corrected, thus forming a desired pattern with high precision.

FIGS. 8 and 9 illustrate graphs of a proximity range changing with an elliptic ratio according to embodiments of the inventive concept. In FIGS. 8 and 9, proximity ranges with respect to elliptic ratios of 0, 0.25, 0.5, 0.75, 1, 1.5, 2, and 3 are shown.

Referring to FIGS. 8 and 9, the region of the proximity range decreases as the elliptic ratio increases and converges toward the reference line. Only a probability function in the proximity range is calculated and a probability function outside the proximity range is not calculated. The elliptic ratio is merely an example of the orientation-dependent component that can be included in the proximity range, and the inventive concept is not limited to this example.

Accordingly, by defining the proximity range to include the orientation-dependent component, the influences of features which are positioned with the same distance, but have different orientations in a particular layout, may be analyzed precisely. In particular, the influences of a feature positioned upwardly perpendicular to the target point and a feature positioned inclined with respect to the target point upon the layout may be analyzed more closely to actual feature influences. Therefore, the layout may be more accurately corrected, thus forming a desired pattern with high precision.

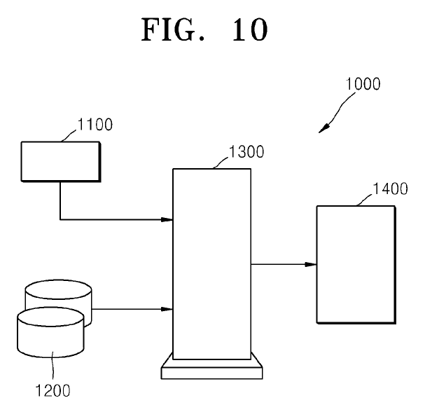

FIG. 10 illustrates a diagram of a system 1000 for executing a method of forming a photomask layout, according to an embodiment of the inventive concept.

Referring to FIG. 10, a computer system 1300 for executing the method of forming a photomask layout may be a computer or a work station that is used for general purposes. The computer system 1300 may be of a stand-alone type or a network type. The computer system 1300 may include a single processor or a multiprocessor for executing operations. The computer system 1300 and may be a parallel-processing computer system. The computer system 1300 executes a sequence of executable instructions recorded on a program storing medium 1100, for example, a compact disc (CD) or a digital video disk (DVD), or transmitted through a wireless/wired communication network such as the Internet. The computer system 1300 is provided with a file containing information about a layout from a layout file storage 1200, for example, a database or another storage medium, and executes an instruction for reading out the file. The computer system 1300 performs etch proximity correction according to an embodiment of the inventive concept with respect to a layout, corrects the layout by using the etch proximity correction, and then forms a file containing information about the processing. Next, the computer system 1300 checks if a desired target layout is formed by performing comparison and verification, after which the target layout is transferred to a mask recording device 1400 by which a photomask or a reticle is fabricated.

The system 1000 includes a providing mechanism configured to provide a layout, a selecting mechanism configured to select a target point on an edge of the layout, a defining mechanism configured to define a proximity range from the target point, a defining mechanism configured to define a probability function including a distance-dependent component, an orientation-dependent component, or both a distance-dependent component and an orientation-dependent component with respect to the proximity range, and a calculating mechanism configured to calculate a surface integral of the probability function over the proximity range.

The system 1000 includes a storage apparatus for storing a layout and a processing apparatus. The processing apparatus receives the layout from the storage apparatus; selects a target point on an edge of the layout; defines a proximity range from the target point; defines a probability function including a distance-dependent component, an orientation-dependent component, or both a distance-dependent component and an orientation-dependent component with respect to the proximity range; and calculates a surface integral of the probability function over the proximity range.

The inventive concept may be embodied as a computer-readable code on a computer-readable recording medium. The recording medium may be all kinds of recording devices storing data that is readable by a computer. Examples of the recording medium include read-only memory (ROM), random access memory (RAM), CD-ROMs, magnetic tapes, floppy disks, and optical data storage devices. The computer-readable recording medium can also be distributed over a network of coupled computer systems so that the computer-readable code is stored and executed in a decentralized fashion. Herein, the program or code stored in the storage medium is a series of instructions directly or indirectly used in a device having an information processing ability, such as a computer, in order to obtain a specific result. Accordingly, the term “computer”, irrespective of the real use of the teini, refers to any device including a memory, an input/output device, and a calculation device, and having an information processing ability to perform a specific function.

The storage medium may store programmed instructions for executing a method of performing etch proximity correction on a computer, the method including providing a layout, selecting a target point on an edge of the layout, defining a proximity range from the target point, defining a probability function including a distance-dependent component, an orientation-dependent component, or both a distance-dependent component and an orientation-dependent component with respect to the proximity range, and calculating a surface integral of the probability function over the proximity range.

The foregoing is illustrative of exemplary embodiments and is not to be construed as limiting thereof. Although exemplary embodiments have been described, those of ordinary skill in the art will readily appreciate that many modifications are possible in the exemplary embodiments without materially departing from the novel teachings and advantages of the exemplary embodiments. Accordingly, all such modifications are intended to be included within the scope of the claims. Exemplary embodiments are defined by the following claims, with equivalents of the claims to be included therein.

What is claimed is:

1. A method of performing etch proximity correction, the method comprising:
providing a layout;
selecting a target point on an edge of the layout;
defining a proximity range from the target point;
defining a probability function comprising at least one of a distance-dependent component and an orientation-dependent component with respect to the proximity range; and
calculating a surface integral of the probability function over the proximity range.

2. The method of claim 1, wherein the orientation-dependent component changes depending on an azimuth from a reference line passing through the target point.

3. The method of claim 2, wherein the reference line extends perpendicular to the edge.

4. The method of claim 2, wherein the orientation-dependent component is symmetric with respect to the reference line.

5. The method of claim 2, wherein the orientation-dependent component decreases as the azimuth increases.

6. The method of claim 2, wherein the orientation-dependent component is proportional to a cosine value of the azimuth.

7. The method of claim 2, wherein the orientation-dependent component further comprises an elliptic ratio.

8. The method of claim 7, wherein the orientation-dependent component is proportional to cos(Er×θ), in which Er represents the elliptic ratio and θ represents the azimuth.

9. The method of claim 2, wherein the orientation-dependent component comprises a Gaussian function of the azimuth having a relationship expressed as:
$$G ( θ ) = a {e}^{- {( \frac{θ}{b} )}^{2}} ,$$
where θ represents the azimuth, a and b represent constants, and G(θ) represents the Gaussian function.

10. The method of claim 2, wherein the orientation-dependent component comprises a Gaussian function of the azimuth having a relationship expressed as:
$$G ( θ ) = a {e}^{- {( \frac{Er θ}{b} )}^{2}} ,$$
where Er represents an elliptic ratio, θ represents the azimuth, a and b represent constants, and G(θ) represents the Gaussian function.

11. The method of claim 1, wherein the distance-dependent component changes depending on a distance from the target point.

12. The method of claim 11, wherein the distance-dependent component decreases as the distance increases.

13. The method of claim 11, wherein the distance-dependent component is proportional to a reciprocal of the distance.

14. The method of claim 11, wherein the distance-dependent component comprises a Gaussian function of the distance having a relationship expressed as:
$$G ( r ) = a {e}^{- {( \frac{r}{b} )}^{2}} ,$$
where r represents the distance, a and b represent constants, and G(r) represents the Gaussian function.

15. The method of claim 1, wherein the proximity range is dependent upon the orientation-dependent component.

16. The method of claim 1, wherein the proximity range changes with an elliptic ratio.

17. The method of claim 1, wherein selecting the target point comprises selecting a middle point of the edge as the target point.

18. A method of forming a photomask layout, the method comprising:
designing a layout;
performing etch proximity correction with respect to the layout; and
correcting the layout using the etch proximity correction,
wherein performing the etch proximity correction comprises:
providing a layout;
selecting a target point on an edge of the layout;
defining a proximity range from the target point;
defining a probability function comprising at least one of a distance-dependent component and an orientation-dependent component with respect to the proximity range; and
calculating a surface integral of the probability function over the proximity range.

19. A computer-readable recording medium storing programmed instructions for executing a method of performing etch proximity correction on a computer, the method comprising:
providing a layout;
selecting a target point on an edge of the layout;
defining a proximity range from the target point;
defining a probability function comprising at lease one of a distance-dependent component and an orientation-dependent component with respect to the proximity range; and
calculating a surface integral of the probability function over the proximity range.

20. A system for performing etch proximity correction, the system comprising:
a providing mechanism configured to provide a layout;
a selecting mechanism configured to select a target point on an edge of the layout;
a defining mechanism configured to define a proximity range from the target point;
a defining mechanism configured to define a probability function including at least one of a distance-dependent component and an orientation-dependent component with respect to the proximity range; and
a calculating mechanism configured to calculate a surface integral of the probability function over the proximity range.

21. A system for performing etch proximity correction, comprising:
a storage apparatus for storing a layout; and
a processing apparatus for receiving the layout from the storage apparatus, the processing apparatus selecting a target point on an edge of the layout, defining a proximity range from the target point, defining a probability function including at least one of a distance-dependent component and an orientation-dependent component with respect to the proximity range, and calculating a surface integral of the probability function over the proximity range.

22. The system of claim 21, wherein the orientation-dependent component changes depending on an azimuth from a reference line passing through the target point.

23. The system of claim 22, wherein the orientation-dependent component decreases as the azimuth increases.

24. The system of claim 22, wherein the orientation-dependent component further comprises an elliptic ratio.

25. The system of claim 21, wherein the distance-dependent component changes depending on a distance from the target point.

26. The system of claim 25, wherein the distance-dependent component decreases as the distance increases.

27. The system of claim 21, wherein the distance-dependent component is proportional to a reciprocal of the distance.

28. The system of claim 21, wherein the proximity range is dependent upon the orientation-dependent component.

29. The system of claim 21, wherein the proximity range changes with an elliptic ratio.
